(19) United States
(12) Patent Application Publication
(10) Pub. No.: US 2025/0167400 A1
(43) Pub. Date: May 22, 2025

(54) SEPARATOR FOR RECHARGEABLE LITHIUM BATTERY AND RECHARGEABLE LITHIUM BATTERY INCLUDING THE SAME

(71) Applicant: SAMSUNG SDI CO., LTD., Yongin-si (KR)

(72) Inventors: Ji Wan YOU, Suwon-si (KR); Ik Hwan CHO, Suwon-si (KR); Chang Hee WOO, Suwon-si (KR); Young Gyoon RYU, Suwon-si (KR); Byeong Do KAWK, Suwon-si (KR); Jin Hwan PARK, Suwon-si (KR)

(73) Assignee: SAMSUNG SDI CO., LTD., Yongin-si (KR)

(21) Appl. No.: 18/956,545

(22) Filed: Nov. 22, 2024

(30) Foreign Application Priority Data
Nov. 22, 2023 (KR) 10-2023-0163561

(51) Int. Cl. H01M 50/451; H01M 10/0525; H01M 50/42; H01M 50/423; H01M 50/426; H01M 50/431; H01M 50/491

(52) U.S. Cl. CPC H01M 50/451; H01M 50/42; H01M 50/423; H01M 50/426; H01M 50/431; H01M 50/491; H01M 10/0525

(57) ABSTRACT

Examples of the disclosure include a separator for a rechargeable lithium battery, and a rechargeable lithium battery including the separator, and a separator for a rechargeable lithium battery including a porous substrate and a coating layer located on at least one surface of the porous substrate. The coating layer includes a binder and a core-shell particle including a fluorine-based resin particle core and a shell of an inorganic fine particle.

### CROSS-REFERENCE TO RELATED APPLICATION

The present application claims the benefit of priority to Korean Patent Application No. 10-2023-0163561, filed on Nov. 22, 2023 in the Korean Intellectual Property Office, the entire disclosure of which being incorporated herein by reference.

### BACKGROUND

### 1. Field of the Disclosure

Examples of the present disclosure relate to a separator for a rechargeable lithium battery, and to a rechargeable lithium battery including the separator.

### 2. Discussion of Related Art

With increasing use of electronic devices, such as, e.g., mobile phones, notebook computers, electric vehicles, and the like, which use batteries, the demand for secondary batteries having high energy density and high capacity is increasing. Therefore, improving the performance of rechargeable lithium batteries may be advantageous.

A rechargeable lithium battery is typically a battery including a positive electrode and a negative electrode that contain an active material capable of the intercalation and deintercalation of lithium ions, and that produces electric energy by oxidation and reduction reactions when the lithium ions are intercalated into and deintercalated from the positive electrode and the negative electrode.

The rechargeable lithium battery may include a separator between the positive electrode and the negative electrode. It may be advantageous that the rechargeable lithium battery has desired or improved puncture strength.

### SUMMARY OF THE DISCLOSURE

An example embodiment includes a separator for a rechargeable lithium battery that achieves desired or improved inorganic fine particle dispersibility, desired or improved puncture strength, and desired or improved puncture strength uniformity.

Another example embodiment includes a rechargeable lithium battery including the separator for a rechargeable lithium battery.

An example embodiment includes a separator for a rechargeable lithium battery, which includes a porous substrate, and a coating layer located on at least one surface of the porous substrate, wherein the coating layer includes a binder and a core-shell particle having a fluorine-based resin particle core and a shell of an inorganic fine particle.

Another example embodiment includes a rechargeable lithium battery including the separator for a rechargeable lithium battery, a positive electrode, and a negative electrode.

### BRIEF DESCRIPTION OF THE DRAWINGS

FIG. 1 is a conceptual diagram of a core-shell particle, according to an example embodiment.

FIG. 2 is a cross-sectional view of a separator for a rechargeable lithium battery, according to an example embodiment.

FIGS. 3-6 are cross-sectional views schematically illustrating a rechargeable lithium battery, according to an example embodiment.

FIG. 7 shows SEM results of the core-shell particle prepared in Example below.

FIG. 8 is an enlarged view of FIG. 7.

FIG. 9 shows results of thermogravimetric analysis of particles prepared in Example and Comparative Example below.

FIG. 10 shows a resulting state when the particles prepared in Example and Comparative Example are dissolved in acetone.

FIG. 11 shows a resulting state when the particles prepared in Example and Comparative Example are dissolved in acetone.

### DETAILED DESCRIPTION

Hereinafter, example embodiments of the present disclosure are described in detail. However, the embodiments are presented as examples, and the present disclosure is not limited thereto, and the present disclosure is only defined by the scope of the appended claims.

Unless otherwise stated herein, when a part such as a layer, a membrane, an area, a plate, etc. is described as being disposed “on” another part, the part includes not only a case where the part is “directly on” another part, but also a case where there are other parts therebetween.

Unless otherwise stated herein, the singular may also include the plural. In addition, unless otherwise stated, the term “A or B” may mean “including A, including B, or including A and B.”

In the present specification, “a combination thereof” may mean a mixture, stack, composite, copolymer, alloy, blend, or reaction product of constituents.

Unless otherwise defined herein, a particle diameter may be an average particle diameter. In addition, the particle diameter refers to an average particle diameter D50, which refers to a diameter of a particle with a cumulative volume of 50% by volume in a particle diameter distribution. The average particle diameter D50 may be measured by methods known to those skilled in the art and for example, may be measured using a particle size analyzer, a transmission electron microscope photograph, or a scanning electron microscope photograph. As another method, the average particle diameter D50 may be obtained by measuring the particle diameter using a measuring device using dynamic light scattering, performing data analysis to count the number of particles for each particle size range, and then calculating the average particle diameter D50 therefrom. Alternatively, the average particle diameter D50 may be measured using a laser diffraction method. When measuring the average particle diameter by the laser diffraction method, for example, the average particle diameter D50 based on 50% of a particle diameter distribution in the measuring device may be calculated by dispersing particles to be measured in a dispersion medium, then introducing the dispersion medium into a commercially available laser diffraction particle diameter measuring device (e.g., Microtrac's MT 3000), and radiating ultrasonic waves of about 28 kHz with an output of 60 W.

In the present specification, “(meth)acryl” refers to acryl and/or methacryl.

Hereinafter, unless otherwise defined, “substitution” means that hydrogen in a compound is substituted with a substituent such as or including at least one of a C1 to C30 alkyl group, a C2 to C30 alkenyl group, a C2 to C30 alkynyl group, a C6 to C30 aryl group, a C7 to C30 alkylaryl group, a C1 to C30 alkoxy group, a C1 to C30 heteroalkyl group, a C3 to C30 heteroalkylaryl group, a C3 to C30 cycloalkyl group, a C3 to C15 cycloalkenyl group, a C6 to C30 cycloalkynyl group, a C2 to C30 heterocycloalkyl group, a halogen (F, Cl, Br, or I), a hydroxy group (—OH), a nitro group (—NO₂), a cyano group (—CN), an amino group (—NRR′) (here, R and R′ are each independently hydrogen or a C1 to C6 alkyl group), a sulfobetaine group (—RR′N+(CH₂)ₙSO₃—, n is a natural number from 1 to 10), a carboxybetaine group (—RR′N+(CH₂)ₙCOO—, n is a natural number from 1 to 10) (here, R and R′ are each independently a C1 to C20 alkyl group), an azido group (—N₃), an amidino group (—C(═NH)NH₂), a hydrazino group (—NHNH₂), a hydrazono group (═N(NH₂)), a carbamoyl group (—C(O)NH₂), a thiol group (—SH), an acyl group (—C(═O)R, here, R denotes hydrogen, a C1 to C6 alkyl group, a C1 to C6 alkoxy group, or a C6 to C12 aryl group), a carboxyl group (—COOH) or a salt thereof (—C(═O) OM, here, M denotes an organic or inorganic cation), a sulfonic acid group (—SO₃H) or a salt thereof (—SO₃M, here, M denotes an organic or inorganic cation), a phosphate group (—PO₃H₂) or a salt thereof (—PO₃MH or —PO₃M₂, here, M denotes an organic or inorganic cation), and a combination thereof.

Hereinafter, the C1 to C3 alkyl group may be or include at least one of a methyl group, an ethyl group, or a propyl group. The C1 to C10 alkylene group may be or include, for example, a C1 to C6 alkylene group, a C1 to C5 alkylene group, or a C1 to C3 alkylene group and may be or include, for example, at least one of a methylene group, an ethylene group, or a propylene group. The C3 to C20 cycloalkylene group may be or include, for example, a C3 to C10 cycloalkylene group, or a C5 to C10 cycloalkylene group, for example, a cyclohexylene group. The C6 to C20 arylene group may be or include, for example, a C6 to C10 arylene group, for example, a phenylene group. The C3 to C20 heterocyclic group may be or include, for example, a C3 to C10 heterocyclic group, for example, a pyridine group.

Hereinafter, “hetero” means including one or more heteroatoms such as or including at least one of N, O, S, Si, and P.

In addition, in the chemical formulas, the symbol * refers to a part that is connected to the same or different atom, group, or structural unit.

Hereinafter, “alkali metal” refers to an element belonging to Group 1 of the periodic table, such as lithium, sodium, potassium, rubidium, cesium, or francium and may be present in a cationic or neutral state.

When the terms “about” or “substantially” are used in this specification in connection with a numerical value, it is intended that the associated numerical value include a tolerance of ±10% around the stated numerical value. Moreover, when reference is made to percentages in this specification, it is intended that those percentages are based on weight, i.e., weight percentages. The expression “up to” includes amounts of zero to the expressed upper limit and all values therebetween. When ranges are specified, the range includes all values therebetween such as increments of 0.1%.

In the present specification, when describing a numerical range, “X to Y” means “X or more and Y or less (X≤ and ≤Y).”

A separator for a rechargeable lithium battery according to an example embodiment includes a porous substrate, and a coating layer located on at least one surface of the porous substrate, in which the coating layer includes a binder and a core-shell particle, and the core-shell particle includes a fluorine-based resin particle core and a shell of an inorganic fine particle.

Because the inorganic fine particle is included in the coating layer in the shell of the core-shell particle, a coating layer with desired or improved inorganic fine particle dispersibility can be provided. Because the coating layer includes the core-shell particle, a separator with desired or improved puncture strength and desired or improved puncture strength uniformity can be provided.

### Coating Layer

The coating layer includes a binder and a core-shell particle.

FIG. 1 is a conceptual diagram of a core-shell particle according to an example embodiment. Referring to FIG. 1, a core-shell particle C is formed as a shell in which a fluorine-based resin particle core A is surrounded by a plurality of inorganic fine particles B.

The inorganic fine particles are not included as separate independent particles in the coating layer and may be included in the shell. The inorganic fine particles may be included in the shell of a core-shell particle in the coating layer, and thus may be included in the coating layer with desired or improved dispersibility. The desired or improved dispersibility can provide a substantially uniform effect, for example, a substantially uniform puncture strength on substantially the entire surface of the separator.

According to an example embodiment, the inorganic fine particles B may be chemically bonded to the fluorine-based resin particle core A. The chemical bonding can increase the bonding strength of the inorganic fine particles B to the fluorine-based resin particle core A, thereby preventing fluorine-based resin particles and the inorganic fine particles from being separated in a process of manufacturing the coating layer, and increasing the structural stability of the core-shell particle even in the coating layer.

The inorganic fine particles may be or include, for example, a ceramic material capable of increasing heat resistance. The inorganic fine particle may include, for example, at least one of a metal oxide, a metalloid oxide, a metal fluoride, a metal hydroxide, or a combination thereof. The inorganic fine particle may include, for example, at least one of alumina (e.g., Al₂O₃), SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof, but is not limited thereto. For example, the inorganic fine particle may be or include alumina.

The inorganic fine particle or particles may be substantially spherical, substantially plate-shaped, substantially cubic, amorphous, or fibrous. For example, the inorganic fine particle may be substantially plate-shaped.

The inorganic fine particle or particles may have a particle diameter D50 that is significantly smaller than the particle diameter of the fluorine-based resin core. Such a small particle diameter can allow the core-shell particle to be readily prepared.

For example, the particle diameter D50 of the inorganic fine particle may range from about 10 nm to about 100 nm, for example 10, 15, 20, 25, 30, 35, 40, 45, 50, 55, 60, 65, 70, 75, 80, 85, 90, 95, 100 nm. Within the above range, the core-shell particle can be readily prepared.

The fluorine-based resin particle may allow the core-shell particle to be readily formed using the inorganic fine particles. According to an example embodiment, the fluorine-based resin particle may be readily chemically bonded to the inorganic fine particles to allow the core-shell particles to be readily formed.

According to an example embodiment, the fluorine-based resin particle may include one or more of a homopolymer particle of a fluorine-based monomer, a copolymer particle of a fluorine-based monomer, and a copolymer particle of a fluorine-based monomer and a comonomer.

The fluorine-based monomer may include one or more of vinylidene fluoride, chlorotrifluoroethylene, trifluoroethylene, hexafluoropropylene, and ethylene tetrafluoride. For example, the fluorine-based monomer may be or include vinylidene fluoride.

The comonomer is or includes a non-fluorine-based monomer, and may include one or more of an ethylene monomer and a propylene monomer. For example, the comonomer may be or include an ethylene monomer.

According to an example embodiment, the fluorine-based resin particle may be or include one or more of poly(vinylidene fluoride) and poly(vinylidene fluoride-co-hexafluoropropylene).

According to an example embodiment, the fluorine-based resin particle may be or include poly(vinylidene fluoride).

According to an example embodiment, the fluorine-based resin particle may be or include poly(vinylidene fluoride-co-hexafluoropropylene), which may be or include a copolymer of vinylidene fluoride and hexafluoropropylene in a molar ratio ranging from about 1:1 to about 1:2. Within the above range, the advantageous effect of the present disclosure can be readily achieved.

The fluorine-based resin particle may have the particle diameter D50 ranging from about 200 nm to 1 about μm, for example about 200 nm, about 250 nm, about 300 nm, about 350 nm, about 400 nm, about 450 nm, about 500 nm, about 550 nm, about 600 nm, about 650 nm, about 700 nm, about 750 nm, about 800 nm, 8 about 50 nm, about 900 nm, about 950 nm, or about 1000 nm. Within the above range, the core-shell particle can be readily prepared.

The fluorine-based resin particle may be substantially spherical, substantially plate-shaped, substantially cubic, or amorphous. For example, the fluorine-based resin particle may be substantially spherical.

The core-shell particle has a particle diameter D50 of about 2 μm or less, for example, in the range of about 200 nm to about 2 μm, or about 200 nm to about 1.5 μm, for example about 200 nm, about 250 nm, about 300 nm, about 350 nm, about 400 nm, about 450 nm, about 500 nm, about 550 nm, about 600 nm, about 650 nm, about 700 nm, about 750 nm, about 800 nm, about 850 nm, about 900 nm, about 950 nm, about 1000 nm, about 1100 nm, about 1200 nm, about 1300 nm, about 1400 nm, about 1500 nm, about 1600 nm, about 1700 nm, about 1800 nm, about 1900 nm, about 2000 nm. Within any of the above ranges, the core-shell particle may be included in the coating layer.

Among 100 wt % of the core-shell particle, the core and shell may be included in a core:shell ratio ranging from about 90 wt %: 10 wt % to about 10 wt %: 90 wt %. Within the above range, the core-shell particle can be readily prepared, and a stable core-shell structure can be maintained. For example, the core and shell may be included in a core:shell ratio equal to, for example, about 10 wt %: 90 wt %, about 20 wt %: 80 wt %, about 30 wt %: 70 wt %, about 40 wt %: 60 wt %, about 50 wt %: 50 wt %, about 60 wt %: 40 wt %, about 70 wt %: 30 wt %, about 80 wt %: 20 wt %, about 90 wt %: 10 wt %, in a range of about 80 wt %: 20 wt % to about 90 wt %: 10 wt %, for example, a range of about 50 wt %: 50 wt % to about 60 wt %: 40 wt %.

The core-shell particles may be included in a desired amount with respect to the binder. According to an example embodiment, the binder and core-shell particle may be included in a binder:core-shell particle weight ratio ranging from about 1:10 to about 1:50, for example, about 1:10, about 1:11, about 1:12, about 1:13, about 1:14, about 1:15, about 1:16, about 1:17, about 1:18, about 1:19, about 1:20, about 1:21, about 1:22, about 1:23, about 1:24, about 1:25, about 1:30, about 1:31, about 1:32, about 1:33, about 1:34, about 1:35, about 1:36, about 1:37, about 1:38, about 1:39, about 1:40, about 1:41, about 1:42, about 1:43, about 1:44, about 1:45, about 1:46, about 1:47, about 1:48, about 1:49, about 1:50, or a range of about 1:20 to about 1:30. Within the above range, the coating layer can be readily manufactured, and the heat resistance and puncture strength of the separator can be readily increased.

The core-shell particle may be prepared by a mechanofusion method. For example, an example method of preparing the core-shell particle is described below.

The method includes a process of preparing a mixture by mixing fluorine-based resin particles and inorganic fine particles in a fluorine-based resin particle:inorganic fine particle weight ratio ranging from about 1:1 to about 1:0.5, filling about 40% to about 80% of a total volume of a mechanofusion chamber with the mixture, and performing dry processing in a temperature in a range of about 25° C. to 30° C. and about 1000 rpm to about 5000 rpm for about 5 minutes to about 15 minutes.

The above process may allow the core-shell particle to be readily prepared. The above process may allow a core-shell particle in which the core and the shell are chemically bonded to be readily prepared.

The binder may be configured to form the coating layer. In addition, the binder may have a high melting point, thereby increasing the heat resistance of the coating layer.

According to an example embodiment, the binder may include one or more of a sulfonate group-containing structural unit, a structural unit derived from (meth)acrylate or (meth)acrylic acid, a cyano group-containing structural unit, and a structural unit derived from (meth)acrylamide.

According to an example embodiment, the binder includes a (meth)acryl-based binder including a sulfonate group-containing structural unit. The (meth)acryl-based binder including a sulfonate group-containing structural unit may be configured for increasing heat resistance when included in the coating layer together with the core-shell particles.

The sulfonate group-containing structural unit may be or include a structural unit containing a conjugate base of at least one of sulfonic acid, a sulfonate salt, sulfonic acid, or a derivative thereof.

For example, the sulfonate group-containing structural unit may be represented by at least one of Chemical Formulas 1, 2, 3, or a combination thereof below.

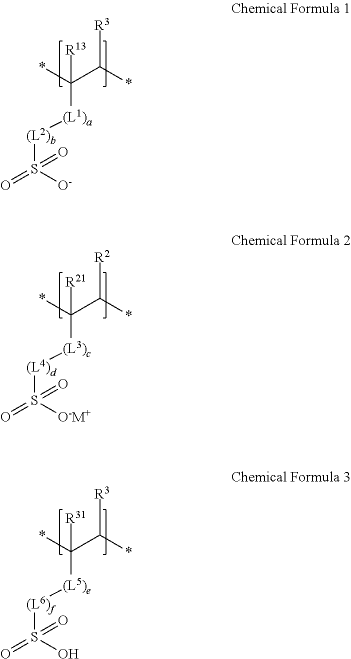

in Chemical Formulas 1 to 3,
R¹, R¹¹, R², R²¹, R³, and R³¹ each independently includes hydrogen or a C1 to C5 alkyl group,
L¹, L³, and L⁵ each independently includes —C(═O)—, —C(═O)O—, —OC(═O)—, —O—, or —C(═O)NH—,
L², L⁴, and L⁶ each independently includes a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 arylene group,
a, b, c, d, e, and f are each independently integers ranging from 0 to 2, and
in Chemical Formula 2,
M is an alkali metal.

For example, in Chemical Formulas 1 to 3,
L¹, L³, and L⁵ each independently includes —C(═O)NH—,
L², L⁴, and L⁶ each independently includes a C1 to C10 alkylene group, and
a, b, c, d, e, and f may each be an integer ranging from 0 to 2.

The sulfonate group-containing structural unit may include only one or two or more of the structural unit represented by Chemical Formula 1, the structural unit represented by Chemical Formula 2, and the structural unit represented by Chemical Formula 3. As an example, the sulfonate group-containing structural unit may include the structural unit represented by Chemical Formula 2, and as another example, the sulfonate group-containing structural unit may include a combination of the structural unit represented by Chemical Formula 2 and the structural unit represented by Chemical Formula 3.

The sulfonate group-containing structural unit may be or include, for example, at least one of a structural unit derived from vinyl sulfonic acid, allyl sulfonic acid, styrene sulfonic acid, anethole sulfonic acid, (meth)acrylamidoalkane sulfonic acid, sulfoalkyl (meth)acrylate, or salts thereof.

Here, the alkane may be or include at least one of a C1 to C20 alkane, a C1 to C10 alkane, or a C1 to C6 alkane, and the alkyl may be or include at least one of a C1 to C20 alkyl, a C1 to C10 alkyl, or a C1 to C6 alkyl. The salt refers to a salt composed of the above-mentioned sulfonic acid and a desired ion. The ion may be or include, for example, an alkali metal ion, and in this case, the salt may be an alkali metal salt of sulfonic acid.

The (meth)acrylamidoalkane sulfonic acid may be or include, for example, at least one of 2-(meth)acrylamido-2-methylpropanesulfonic acid, and the sulfoalkyl (meth)acrylate may be or include, for example, at least one of 2-sulfoethyl(meth)acrylate, 3-sulfopropyl (meth)acrylate, etc.

The sulfonate group-containing structural unit may be included in the (meth)acryl-based binder in an amount ranging from about 0.1 mol % to about 20 mol %, for example, from about 0.1 mol % to about 10 mol %, from about 1 mol % to about 20 mol %, or from about 1 mol % to about 10 mol %. Within any of the above ranges, the (meth)acryl-based binder and the separator including the same can exhibit desired or improved bonding strength, heat resistance, air permeability, and oxidation resistance.

In the structural unit derived from the (meth)acrylate or the (meth)acrylic acid, the (meth)acrylate may be or include at least one of a conjugate base of (meth)acrylic acid, a (meth)acrylic acid salt, or a derivative thereof. The structural unit derived from the (meth)acrylate or the (meth)acrylic acid may be represented, for example, by Chemical Formulas 4, 5, 6, or a combination thereof, below:

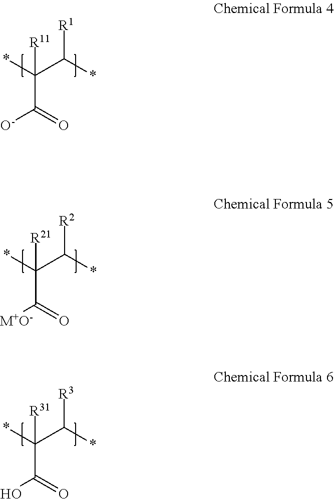

in Chemical Formulas 4 to 6:
R¹, R¹¹, R², R²¹, R³, and R³¹ each independently includes hydrogen or a methyl group, and
in Chemical Formula 6,
M includes an alkali metal.

The alkali metal may be or include, for example, at least one of lithium, sodium, potassium, rubidium, or cesium.

The structural unit derived from the (meth)acrylate or the (meth)acrylic acid may be included in the (meth)acryl-based binder in an amount ranging from 0 mol % to about 70 mol %, for example, from about 10 mol % to about 70 mol %, from about 20 mol % to about 60 mol %, from about 30 mol % to about 60 mol %, and from about 40 mol % to about 55 mol %. When included in any of the above ranges, a separator containing the (meth)acryl-based binder can exhibit desired or improved bonding strength, heat resistance, air permeability, and oxidation resistance.

The cyano group-containing structural unit may be, for example, represented by Chemical Formula 7 below:

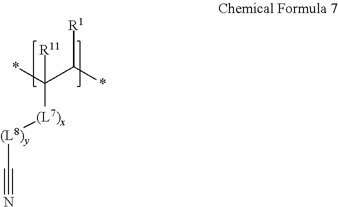

in Chemical Formula 7:
R¹ and R¹¹ each independently includes hydrogen or a C1 to C5 alkyl group,
L⁷ includes —C(═O)—, —C(═O)O—, —OC(═O)—, —O—, or —C(═O)NH—,
x is an integer ranging from 0 to 2,
L⁸ includes a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group, and
y is an integer ranging from 0 to 2.

The cyano group-containing structural unit may be or include, for example, at least one of a structural unit derived from (meth)acrylonitrile, an alkene nitrile, cyanoalkyl (meth)acrylate, or 2-(vinyloxy)alkanenitrile. Here, the alkene may be or include at least one of a C1 to C20 alkene, a C1 to C10 alkene, or a C1 to C6 alkene, the alkyl may be or include at least one of a C1 to C20 alkyl, a C1 to C10 alkyl, or a C1 to C6 alkyl, and the alkane may be or include at least one of a C1 to C20 alkane, a C1 to C10 alkane, or a C1 to C6 alkane.

The alkene nitrile may be or include, for example, at least one of allyl cyanide, 4-pentenenitrile, 3-pentenenitrile, 2-pentenenitrile, 5-hexenenitrile, etc. The cyanoalkyl (meth)acrylate may be or include, for example, at least one of cyanomethyl (meth)acrylate, cyanoethyl (meth)acrylate, cyanopropyl (meth)acrylate, cyanooctyl (meth)acrylate, etc. The 2-(vinyloxy)alkanenitrile may be or include, for example, 2-(vinyloxy) ethanenitrile or 2-(vinyloxy) propanenitrile.

The cyano group-containing structural unit may be included in the (meth)acryl-based binder in an amount ranging from 0 mol % to about 85 mol %, for example, from about 30 mol % to about 85 mol %, from about 30 mol % to about 70 mol %, from about 30 mol % to about 60 mol %, or from about 35 mol % to about 55 mol %. When the cyano group-containing structural unit is included within any of the above ranges, the (meth)acryl-based binder and the separator including the same can achieve a desired or improved oxidation resistance and exhibit a desired or improved bonding strength, heat resistance, and air permeability.

The structural unit derived from (meth)acrylamide may be represented by Chemical Formula 8 below.

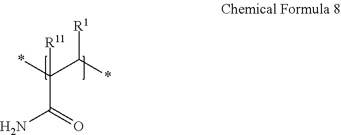

in Chemical Formula 8, R¹ and R¹¹ each independently includes hydrogen or a methyl group.

In an example embodiment, the structural unit derived from (meth)acrylamide may be included in an amount ranging from about 50 mol % to about 95 mol %, for example, from about 50 mol % to about 90 mol % or from about 60 mol % to about 90 mol % with respect to 100 mol % of the (meth)acryl-based binder.

According to an example embodiment, the (meth)acryl-based binder may include at least one of a sulfonate group-containing structural unit, a structural unit derived from (meth)acrylate or (meth)acrylic acid, and a cyano group-containing structural unit. According to an example embodiment, the total amount of the sulfonate group-containing structural unit, the structural unit derived from the (meth)acrylate or the (meth)acrylic acid, and the cyano group-containing structural unit included in the binder may be about 95 mol % or more, for example, in the range of about 99 mol % to about 100 mol %, or about 100 mol %. Within the above range, the above-described advantages of the separator can be readily achieved.

According to an example embodiment, the (meth)acryl-based binder may include at least one of a sulfonate group-containing structural unit, a structural unit derived from (meth)acrylate or (meth)acrylic acid, and a structural unit derived from (meth)acrylamide. According to an example embodiment, the total amount of the sulfonate group-containing structural unit, the structural unit derived from (meth)acrylate or (meth)acrylic acid, and the structural unit derived from (meth)acrylamide included in the binder may be about 95 mol % or more, for example, in the range of about 99 mol % to about 100 mol %, or about 100 mol % in the binder. Within the above range, the above-described advantages of the separator can be readily achieved.

The (meth)acryl-based binder may include an alkali metal. The alkali metal may be present in the form of a cation and for example, may be or include at least one of lithium, sodium, potassium, rubidium, or cesium. For example, the alkali metal may be combined with the (meth)acryl-based binder and may be present in the form of a salt. The alkali metal may be configured to assist in the synthesis of the (meth)acryl-based binder in an aqueous solvent, to increase the bonding strength of the coating layer, and to increase the heat resistance, air permeability, oxidation resistance, and the like, of the separator.

The alkali metal may be included in an amount ranging from about 1 wt % to about 40 wt % of the alkali metal and the (meth)acryl-based binder, for example, from about 1 wt % to about 30 wt %, from about 1 wt % to about 20 wt %, or from about 10 wt % to about 20 wt %. For example, the (meth)acryl-based binder and the alkali metal may be included in a weight ratio of about 99:1 to about 60:40, a weight ratio of about 99:1 to about 70:30, for example, a weight ratio of about 99:1 to about 80:20, or for example, a weight ratio of about 90:10 to about 80:20.

In addition, the alkali metal may be included in an amount ranging from about 0.1 mol % to about 1.0 mol % with respect to the total content of the alkali metal and the (meth)acryl-based binder. When the alkali metal is included within any the above ranges, the coating layer can have a desired or improved bonding strength, and a separator including the same may exhibit a desired or improved heat resistance, air permeability, and oxidation resistance.

A degree of substitution of the alkali metal (M⁺) in the (meth)acryl-based binder may be in the range of about 0.5 to about 1.0, for example, about 0.6 to about 0.9 or about 0.7 to about 0.9 with respect to (k+n). When the degree of substitution of the alkali metal satisfies any of the above ranges, the (meth)acryl-based binder and the separator including the same can exhibit desired or improved bonding strength, heat resistance, and oxidation resistance.

The (meth)acryl-based binder may be in various forms, such as an alternating polymer in which the units are alternately distributed, a random polymer in which the units are randomly distributed, or a graft polymer in which some structural units are grafted.

A weight average molecular weight (Mw) of the (meth)acryl-based binder may be in the range of about 200,000 g/mol to about 700,000 g/mol, for example, about 200,000 g/mol to about 600,000 g/mol, or for example, about 300,000 g/mol to about 600,000 g/mol. When the weight average molecular weight of the (meth)acryl-based binder satisfies any of the above ranges, the (meth)acryl-based binder and the separator including the same can exhibit a desired or improved bonding strength, heat resistance, air permeability, and oxidation resistance. The weight average molecular weight may be or include a polystyrene-converted average molecular weight measured using gel permeation chromatography.

A glass transition temperature of the (meth)acryl-based binder may be in the range of about 200° C. to about 280° C., for example, about 210° C. to about 270° C., or for example, about 210° C. to about 260° C. When the glass transition temperature of the (meth)acryl-based binder satisfies the above range, the (meth)acryl-based binder and the separator including the same can exhibit a desired or improved bonding strength, heat resistance, air permeability, and oxidation resistance. The glass transition temperature may be a value measured by differential scanning calorimetry.

The (meth)acryl-based binder may be prepared by a solution polymerization method.

According to an example embodiment, the (meth)acryl-based binder may be contained in the coating layer of the separator in the form of a film.

The coating layer may have a thickness in the range of about 0.01 μm to about 20 μm, and within the above range, may have a thickness in the range of about 1 μm to about 10 μm, about 1 μm to about 5 μm, or about 1 μm to about 3 μm.

A ratio of the thickness of the coating layer to the thickness of the porous substrate may be in the range of about 0.05 to about 0.5, for example, about 0.05 to about 0.4, about 0.05 to about 0.3, or about 0.1 to about 0.2. Within any of the above ranges, the separator can exhibit a desired or improved air permeability, heat resistance, and bonding strength. Here, the “thickness of the coating layer” indicates a thickness of one coating layer when the coating layer is formed on only one surface of the porous substrate and a thickness of two coating layers when the coating layer is formed on both surfaces of the porous substrate.

### Porous Substrate

The porous substrate may be or include a substrate having multiple pores and commonly used in electrochemical devices. The porous substrate may be or include a polymer membrane formed of or including any one polymer such as or including at least one of a polyolefin such as polyethylene or polypropylene, polyester such as polyethylene terephthalate or polybutylene terephthalate, polyacetal, polyamide, polyimide, polycarbonate, polyether ether ketone, polyaryl ether ketone, polyetherimide, a polyamideimide, polybenzimidazole, polyethersulfone, polyphenylene oxide, cyclic olefin copolymer, polyphenylene sulfide, polyethylene naphthalate, glass fiber, Teflon, and polytetrafluoroethylene, or a copolymer or mixture of two or more types thereof.

The porous substrate may be or include, for example, a polyolefin-based substrate containing a polyolefin, and the polyolefin-based substrate may have a desired or improved shutdown function, thereby contributing to increasing the safety of the battery. The polyolefin-based substrate may be or include at least one of, for example, a polyethylene single film, a polypropylene single film, a polyethylene/polypropylene double film, a polypropylene/polyethylene/polypropylene triple film, and a polyethylene/polypropylene/polyethylene triple film. For example, the polyolefin-based resin may include a non-olefin resin in addition to an olefin resin or include a copolymer of olefin and non-olefin monomers.

The porous substrate may have a thickness in the range of about 1 μm to about 40 μm, for example, about 1 μm to about 30 μm, about 1 μm to about 20 μm, or about 5 μm to about 15 μm.

The separator may further include an adhesive binder.

### Adhesive Binder

The adhesive binder may increase the bonding strength between an electrode, such as a positive electrode or a negative electrode, and the separator, thereby increasing the degree of bonding between the separator and the electrode.

The adhesive binder may include, for example, one or more of a crosslinked or non-crosslinked (meth)acryl-based adhesive binder and a crosslinked or non-crosslinked fluorine-based adhesive binder. As each of the (meth)acryl-based adhesive binder and the fluorine-based binder, common types known to those skilled in the art may be used.

According to an example embodiment, the adhesive binder may have a glass transition temperature of about 50° C. or higher, for example, in the range of about 50° C. to about 100° C.

According to an example embodiment, the adhesive binder may be included in the coating layer. For example, because the coating layer may be formed of or include a composition including the (meth)acryl-based binder, the filler, and the adhesive binder, the coating layer may include the (meth)acryl-based binder, the filler, and the adhesive binder.

According to another example embodiment, the adhesive binder forms an adhesive layer, and the adhesive layer may be located on the coating layer.

The separator for a rechargeable lithium battery according to an example embodiment may have a desired or improved bonding strength. For example, the separator for a rechargeable lithium battery may have a bonding strength of about 0.05 gf/mm or more, for example, in the range of about 0.05 gf/mm to about 0.1 gf/mm, for example, about 0.05 gf/mm to about 0.2 gf/mm. The bonding strength may be measured by a method discussed below.

A separator for a rechargeable lithium battery is located between a positive electrode and a negative electrode, and the separator is bonded to the positive electrode and the negative electrode by passing between rolls with a pressure of 250 kgf at a speed of 150 mm/sec in an 80° C. chamber. A sample is produced by cutting the separator bonded to the positive electrode and the negative electrode to a width of 25 mm and a length of 50 mm. A texture analyzer (TA) is used as a bonding strength measurement device. In the above sample, the separator is separated from a negative electrode plate by about 10 to 20 mm, then the separator is fixed to an upper grip and the negative electrode plate is fixed to a lower grip so that a gap between the grips is 20 mm, and then peeled by being pulled in a 180° direction. After the peeling is started at a peeling speed of 20 mm/min, an average value was obtained by measuring a force required to peel 40 mm three times. The average value is calculated as the average value of the measured values.

The separator for a rechargeable lithium battery according to an example embodiment may exhibit desired or improved air permeability and have an air permeability value of, for example, less than about 200 sec/100 cc, for example, about 190 sec/100 cc or less, or about 180 sec/100 cc or less. Herein, the air permeability refers to the time (seconds) it takes for 100 cc of air to pass through the unit thickness of the separator at a constant pressure. The air permeability per unit thickness may be obtained by measuring the air permeability for the total thickness of the separator and dividing the air permeability by the thickness. The air permeability may be obtained by measuring the time it takes for 100 cc of air to pass through the separator using air permeability measuring equipment (EG01-55-1MR, Asahi Seiko Co., Ltd.).

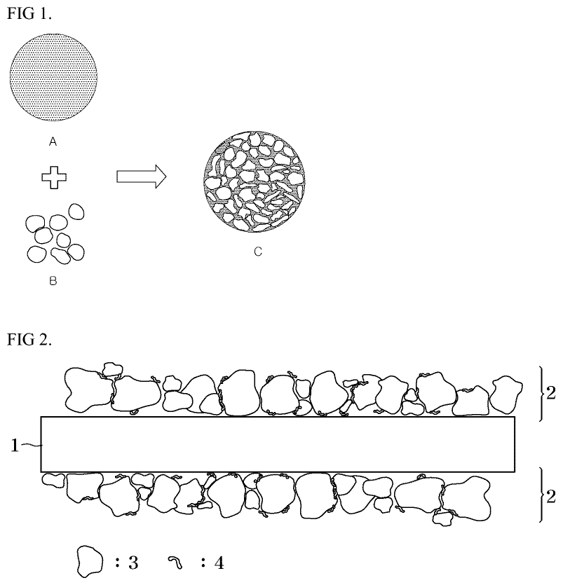

FIG. 2 is a cross-sectional view illustrating a separator for a rechargeable lithium battery, according to an example embodiment. Referring to FIG. 2, the separator for a rechargeable lithium battery includes a porous substrate 1 and a coating layer 2 located on both surfaces of the porous substrate 1. The coating layer 2 includes core-shell particles 3 and a binder 4.

### Rechargeable Lithium Battery

According to an example embodiment, the rechargeable lithium battery includes the separator for a rechargeable lithium battery, a positive electrode, and a negative electrode.

The separator for rechargeable lithium battery corresponds to the separator described above. The separator for rechargeable lithium battery may be positioned between the positive electrode and the negative electrode.

### Positive Electrode

A positive electrode for a rechargeable lithium battery may include a current collector and a positive electrode active material layer on the current collector. The positive electrode active material layer may include a positive electrode active material, and may further include a binder and/or a conductive material.

For example, the positive electrode may further include an additive that can constitute a sacrificial positive electrode.

### Positive Electrode Active Material

The positive electrode active material may include a compound (lithiated intercalation compound) that is capable of intercalating and deintercalating lithium. For example, at least one of a composite oxide of lithium and a metal such as or including at least one of cobalt, manganese, nickel, and combinations thereof may be used.

The composite oxide may be or include a lithium transition metal composite oxide. Examples of the composite oxide may include at least one of lithium nickel-based oxide, lithium cobalt-based oxide, lithium manganese-based oxide, lithium iron phosphate-based compound, cobalt-free nickel-manganese-based oxide, or a combination thereof.

As an example, the following compounds represented by any one of the following Chemical Formulas may be used. LiₐA_{1-b}XbO_{2-c}D_{c} (0.90≤a≤1.8, 0≤b≤0.5, and 0≤c≤0.05); LiₐMn_{2-b}X_{b}O_{4-c}D_{c} (0.90≤a≤1.8, 0≤b≤0.5, and 0≤c≤0.05); LiₐNi_{1-b-c}CO_{b}X_{c}O₂₋ₐDₐ (0.90≤a≤1.8, 0≤b≤0.5, 0≤c≤0.5, and 0<α<2); LiₐNi_{1-b-c}Mn_{b}X_{c}O₂₋ₒDₐ (0.90≤a≤1.8, 0≤b≤0.5, 0≤c≤0.5, and 0≤α≤2); LiₐNi_{b}Co_{c}L¹_{d}GₑO₂ (0.90≤a≤1.8, 0≤b≤0.9, 0≤c≤0.5, 0≤d≤0.5, and 0≤e≤0.1); LiₐNiG_{b}O₂ (0.90≤a≤1.8 and 0.001≤b≤0.1); LiₐCoG_{b}O₂ (0.90≤a≤1.8 and 0.001≤b≤0.1); LiₐMn_{1-b}G_{b}O₂ (0.90≤a≤1.8 and 0.001≤b≤0.1); LiₐMn₂G_{b}O₄ (0.90≤a≤1.8 and 0.001≤b≤0.1); LiₐMn_{1-g}G_{g}PO₄ (0.90≤a≤1.8 and 0≤g≤0.5); Li_{(3-f)}Fe₂(PO₄)₃ (0≤f≤2); or LiₐFePO₄ (0.90≤a≤1.8).

In the above Chemical Formulas, A is or includes at least one of Ni, Co, Mn, or a combination thereof; X is or includes at least one of Al, Ni, Co, Mn, Cr, Fe, Mg, Sr, V, a rare earth element or a combination thereof; D is or includes at least one of O, F, S, P, or a combination thereof; G is or includes at least one of Al, Cr, Mn, Fe, Mg, La, Ce, Sr, V, or a combination thereof; and L¹ is or includes at least one of Mn, Al, or a combination thereof.

The positive electrode active material may be or include, for example, a high nickel-based positive electrode active material having a nickel content that is greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium in the lithium transition metal composite oxide. The high-nickel-based positive electrode active material may be capable of achieving high capacity, and can be applied to a high-capacity, high-density rechargeable lithium battery.

An amount of the positive electrode active material may be in a range of about 90 wt % to about 99.5 wt % based on 100 wt % of the positive electrode active material layer. Amounts of the binder and the conductive material may be in a range of about 0.5 wt % to about 5 wt %, respectively, based on 100 wt % of the positive electrode active material layer.

The binder is configured to attach the positive electrode active material particles to each other and also to attach the positive electrode active material to the current collector. Examples of the binder may include at least one of polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, as non-limiting examples.

The conductive material may be configured to impart conductivity (e.g., electrical conductivity) to the electrode. Any material that does not cause chemical change (e.g., that does not cause an undesirable chemical change in the rechargeable lithium battery) and that conducts electrons can be included in the battery. Examples of the conductive material may include a carbon-based material such as at least one of natural graphite, artificial graphite, carbon black, acetylene black, ketjen black, a carbon fiber, a carbon nanofiber, and carbon nanotube; a metal-based material containing at least one of copper, nickel, aluminum, silver, and the like, in a form of a metal powder or a metal fiber; a conductive polymer such as a polyphenylene derivative; or a mixture thereof.

Al may be included as the current collector, but is not limited thereto.

### Negative Electrode

The negative electrode for a rechargeable lithium battery may include a current collector and a negative electrode active material layer on the current collector. The negative electrode active material layer may include a negative electrode active material, and may further include a binder and/or a conductive material (e.g., an electrically conductive material).

For example, the negative electrode active material layer may include about 90 wt % to about 99 wt % of the negative electrode active material, about 0.5 wt % to about 5 wt % of the binder, and about 0 wt % to about 5 wt % of the conductive material.

### Negative Electrode Active Material

The negative electrode active material may include a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon-based negative electrode active material, such as, for example, crystalline carbon, amorphous carbon or a combination thereof. The crystalline carbon may be graphite such as non-shaped, sheet-shaped, flake-shaped, sphere-shaped, or fiber-shaped, natural graphite or artificial graphite. The amorphous carbon may be or include at least one of a soft carbon, a hard carbon, a mesophase pitch carbonization product, calcined coke, and the like.

The lithium metal alloy includes an alloy of lithium and a metal such as or including at least one of Na, K, Rb, Cs, Fr, Be, Mg, Ca, Sr, Si, Sb, Pb, In, Zn, Ba, Ra, Ge, Al, and Sn.

The material capable of doping/dedoping lithium may be or include a Si-based negative electrode active material or a Sn-based negative electrode active material. The Si-based negative electrode active material may include at least one of silicon, a silicon-carbon composite, SiOx (0<x<2), a Si-Q alloy (where Q is or includes at least one of an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include at least one of Sn, SnO₂, a Sn-based alloy, or a combination thereof.

The silicon-carbon composite may be or include a composite of silicon and amorphous carbon. According to an example embodiment, the silicon-carbon composite may be in the form of silicon particles, and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may be dispersed in an amorphous carbon matrix.

The silicon-carbon composite may further include crystalline carbon. For example, the silicon-carbon composite may include a core including crystalline carbon and silicon particles, and an amorphous carbon coating layer on a surface of the core.

The Si-based negative electrode active material or the Sn-based negative electrode active material may be combined with a carbon-based negative electrode active material.

The binder may be configured to attach the negative electrode active material particles to each other, and also to attach the negative electrode active material to the current collector. The binder may include a non-aqueous binder, an aqueous binder, a dry binder, or a combination thereof.

The non-aqueous binder may include at least one of polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, or a combination thereof.

The aqueous binder may be or include at least one of a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resins, polyvinyl alcohol, and a combination thereof.

When an aqueous binder is the negative electrode binder, a cellulose-based compound capable of imparting viscosity may be further included. The cellulose-based compound may include at least one of carboxymethyl cellulose, hydroxypropylmethyl cellulose, methyl cellulose, or an alkali metal salt thereof. The alkali metal may include at least one of Na, K, or Li.

The dry binder may be or include a polymer material that is capable of being fibrous. For example, the dry binder may be or include at least one of polytetrafluoroethylene, polyvinylidene fluoride, a polyvinylidene fluoride-hexafluoropropylene copolymer, polyethylene oxide, or a combination thereof.

The conductive material may be configured to impart conductivity (e.g., electrical conductivity) to the electrode. Any material that does not cause chemical change (e.g., that does not cause an undesirable chemical change in the rechargeable lithium battery) and that conducts electrons can be included in the battery. Non-limiting examples thereof may include a carbon-based material such as or including at least one of natural graphite, artificial graphite, carbon black, acetylene black, ketjen black, a carbon fiber, a carbon nanofiber, and a carbon nanotube; a metal-based material including at least one of copper, nickel, aluminum, silver, etc. in the form of a metal powder or a metal fiber; a conductive polymer such as a polyphenylene derivative; or a mixture thereof.

The negative current collector may include at least one of a copper foil, a nickel foil, a stainless steel foil, a titanium foil, a nickel foam, a copper foam, a polymer substrate coated with a conductive metal, or a combination thereof.

The rechargeable lithium battery may further include an electrolyte solution.

### Electrolyte Solution

The electrolyte solution for a rechargeable lithium battery may include a non-aqueous organic solvent and a lithium salt.

The non-aqueous organic solvent may be a medium for transmitting ions taking part in the electrochemical reaction of a battery.

The non-aqueous organic solvent may be or include at least one of a carbonate-based, ester-based, ether-based, ketone-based, or alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like.

The ester-based solvent may include at least one of methyl acetate, ethyl acetate, n-propyl acetate, dimethyl acetate, methyl propionate, ethyl propionate, decanolide, mevalonolactone, valerolactone, caprolactone, and the like.

The ether-based solvent may include at least one of dibutyl ether, tetraglyme, diglyme, dimethoxyethane, 2-methyltetrahydrofuran, 2,5-dimethyltetrahydrofuran, tetrahydrofuran, and the like. In addition, the ketone-based solvent may include cyclohexanone, and the like. The alcohol-based solvent may include at least one of ethanol, isopropyl alcohol, and the like. The aprotic solvent may include at least one of nitriles such as R—CN (wherein R is a C2 to C20 linear, branched, or cyclic hydrocarbon group, a double bond, an aromatic ring, or an ether bond, and the like); amides such as dimethylformamide; dioxolanes such as 1,3-dioxolane, 1,4-dioxolane, and the like; sulfolanes, and the like.

The non-aqueous organic solvents may be included alone or in combination of two or more solvents.

In addition, when using a carbonate-based solvent, a cyclic carbonate and a chain carbonate may be mixed, and the cyclic carbonate and the chain carbonate may be mixed in a volume ratio in a range of about 1:1 to about 1:9.

The lithium salt dissolved in the organic solvent is configured to supply lithium ions in a battery, to enable a basic operation of a rechargeable lithium battery, and to improve transportation of the lithium ions between positive and negative electrodes. Examples of the lithium salt include at least one of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (wherein x and y are integers of 1 to 20), lithium trifluoromethane sulfonate, lithium tetrafluoroethanesulfonate, lithium difluorobis(oxalato)phosphate (LiDFOB), and lithium bis(oxalato) borate (LiBOB).

The rechargeable lithium battery may be classified into cylindrical, prismatic, pouch, or coin-type batteries, and the like depending on their shape.

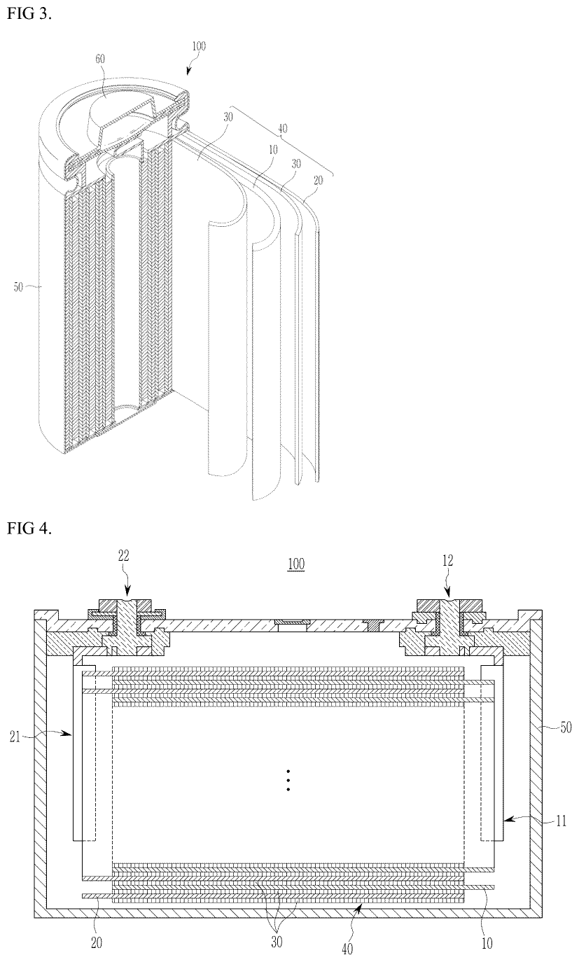

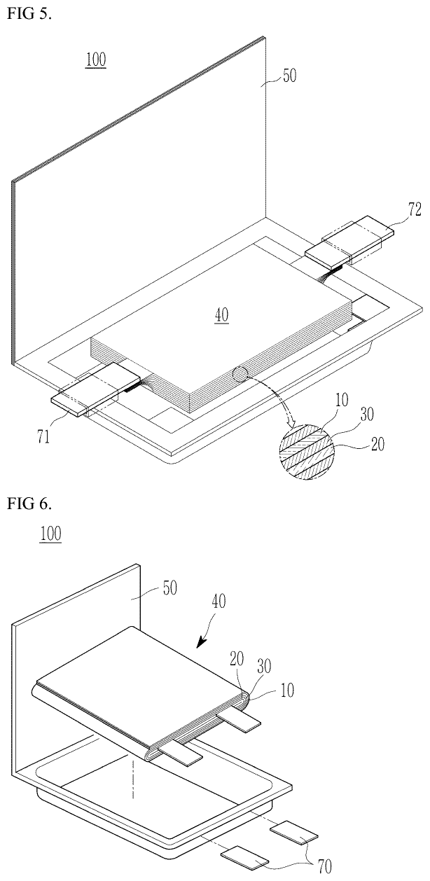

FIGS. 3-6 are schematic views illustrating a rechargeable lithium battery according to an example embodiment. FIG. 3 illustrates a cylindrical battery, FIG. 4 illustrates a prismatic battery, and FIGS. 5 and 6 illustrate pouch-type batteries. Referring to FIGS. 3 to 6, the rechargeable lithium battery 100 may include an electrode assembly 40 including a separator 30 between a positive electrode 10 and a negative electrode 20, and a case 50 in which the electrode assembly 40 is included. The positive electrode 10, the negative electrode 20, and the separator 30 may be impregnated with an electrolyte solution (not shown). The rechargeable lithium battery 100 may include a sealing member 60 sealing the case 50, as shown in FIG. 3. In FIG. 4, the rechargeable lithium battery 100 may include a positive lead tab 11, a positive terminal 12, a negative lead tab 21, and a negative terminal 22. As shown in FIGS. 5 and 6, the rechargeable lithium battery 100 may include an electrode tab 70 illustrated in FIG. 6, or may include, for example, a positive electrode tab 71 and a negative electrode tab 72 illustrated in FIG. 5, the electrode tabs 70/71/72 forming an electrical path for inducing the current formed in the electrode assembly 40 to the outside of the battery 100.

The rechargeable lithium battery according to an example embodiment may be applicable to automobiles, mobile phones, and/or various types of electric devices, as non-limiting examples.

The following Examples and Comparative Examples are provided in order to highlight characteristics of one or more example embodiments, but it is understood that the Examples and Comparative Examples are not to be construed as limiting the scope of the example embodiments, nor are the Comparative Examples to be construed as being outside the scope of the example embodiments. Further, it is understood that the example embodiments are not limited to the particular details described in the Examples and Comparative Examples.

### Preparing Example 1

A core-shell particle having a poly(vinylidene fluoride) core and an alumina shell was prepared by charging a mixture of 30 g of poly(vinylidene fluoride) (PVDF) (spherical, particle diameter D50: 200 nm) and 20 g of alumina (plate-shaped, particle diameter D50: 30 nm) to 40% of the total volume of a chamber of the mechanofusion device (Mini Nobilta, HOSOKAWA MICRON) and processing the mixture at a chamber rotational speed of 3000 rpm for 15 minutes.

### Preparing Example 2

A core-shell particle having a poly(vinylidene fluoride) core and an alumina shell was prepared by charging a mixture of 25 g of poly(vinylidene fluoride) (spherical, particle diameter D50: 1 μm) and 25 g of alumina (plate-shaped, particle diameter D50: 100 nm) to 40% of the total volume of the chamber and processing the mixture at a chamber rotational speed of 3000 rpm for 15 minutes.

### Preparing Example 3

A composite of poly(vinylidene fluoride) and alumina was prepared by mixing 30 g of poly(vinylidene fluoride) (spherical, particle diameter D50: 200 nm) and 20 g of alumina (plate-shaped, particle diameter D50: 30 nm) for 48 hours in a three roll mechanical device.

### Preparing Example 4

A composite of poly(vinylidene fluoride) and alumina was prepared by mixing 25 g of poly(vinylidene fluoride) (spherical, particle diameter D50: 1 μm) and 25 g of alumina (plate-shaped, particle diameter D50: 100 nm) for 48 hours in a three roll mechanical device.

### Example 1

### Preparation of Binder

In a 10 L four-necked flask provided with a stirrer, a thermometer, and a cooling tube, a process of adding distilled water (6361 g), acrylic acid (72.06 g, 1.0 mol), acrylamide (604.1 g, 8.5 mol), potassium persulfate (2.7 g, 0.01 mol), 2-acrylamido-2-methylpropanesulfonic acid (103.6 g, 0.5 mol), and a 5N aqueous lithium hydroxide solution (1.05 equivalents with respect to a total amount of 2-acrylamido-2-methylpropanesulfonic acid), then reducing an internal pressure to 10 mmHg using a diaphragm pump, and returning the internal pressure to a normal pressure using nitrogen was repeated three times.

The reaction was carried out for 12 hours while controlling the temperature of the reaction solution to be stable between 65° C. and 70° C. After cooling to room temperature, the pH of the reaction solution was adjusted to 7 to 8 using a 25% aqueous ammonia solution.

In this way, poly(acrylic acid-co-acrylamide-co-2-acrylamide-2-methylpropanesulfonic acid) sodium salt (melting point: 170° C.) was prepared. A molar ratio of acrylic acid, acrylamide, and 2-acrylamido-2-methylpropanesulfonic acid was 20:75:5 (binder 2) based on 100 moles of total moles. A non-volatile component in about 10 mL of the reaction solution (reaction product) was measured and the measurement result was 9.5 wt % (theoretical value: 10%).

### Manufacture of Separator

A slurry for forming a coating layer having a solid content of 20 wt % was prepared by mixing the prepared (meth)acryl-based binder and the core-shell particle of Preparing Example 1 in a weight ratio of 1:30 and mixing deionized water as a solvent. A separator for a rechargeable lithium battery having a coating layer (thickness: 2.0 μm) was manufactured by coating one surface of a polyethylene-based film (thickness: 5.5 μm, SK Company, air permeability: 120 sec/100 cc, puncture strength: 480 kgf) as a porous substrate with the slurry for forming a coating layer using a die coating method and then drying and aging the same in an oven at 80° C. for 16 hours.

### Example 2

A separator for a rechargeable lithium battery was manufactured in the same method as in Example 1, with a difference that in Example 1, the core-shell particle of Preparing Example 2 was used instead of the core-shell particle of Preparing Example 1.

### Example 3

### Preparation of Binder

In a 3 L four-necked flask provided with a stirrer, a thermometer, and a cooling tube, a process of adding distilled water (968 g), acrylic acid (AA) (54.00 g, 0.62 mol), ammonium persulfate (0.65 g, 2.85 mol), 2-acrylamido-2-methylpropanesulfonic acid (AMPS) (6.00 g, 0.02 mol), and a 20% aqueous sodium hydroxide solution (0.8 equivalents with respect to the total amount of acrylic acid and 2-acrylamido-2-methylpropanesulfonic acid), then reducing an internal pressure to 10 mmHg using a diaphragm pump, and returning the internal pressure to a normal pressure using nitrogen was repeated three times, and then acrylonitrile (AN) (60.00 g, 0.94 mol) was added.

The reaction was carried out for 18 hours while controlling the temperature of a reaction solution to be stable between 65° C. and 70° C., and after adding ammonium persulfate (0.22 g, 0.95 mol) for the second time, the temperature was raised to 80° C., and the reaction was carried out for another 4 hours. After cooling to room temperature, the pH of the reaction solution was adjusted to 7 to 8 using a 25% aqueous ammonia solution.

Accordingly, poly(acrylic acid-co-acrylic acid lithium salt-co-acrylonitrile-co-2-acrylamido-2-methylpropanesulfonic acid lithium salt) as an acryl-based binder (binder 1) was prepared. A molar ratio of acrylic acid+acrylic acid lithium salt, acrylonitrile, and 2-acrylamido-2-methylpropanesulfonic acid lithium salt was 39:59:2 (binder 1) based on 100 moles of total moles. A non-volatile component in about 10 mL of the reaction solution (reaction product) was measured and the measurement result was 9.0 wt % (theoretical value: 10%).

A separator was manufactured in the same method as in Example 1 using the prepared binder.

### Example 4

A separator for a rechargeable lithium battery was manufactured in the same method as in Example 1, with a difference that in Example 3, the core-shell particle of Preparing Example 2 was used instead of the core-shell particle of Preparing Example 1.

### Comparative Example 1

A separator for a rechargeable lithium battery was manufactured in the same method as in Example 1, with a difference that in Example 1, the composite of Preparing Example 3 was used instead of the core-shell particle of Preparing Example 1.

### Comparative Example 2

A separator for a rechargeable lithium battery was manufactured in the same method as in Example 1, with a difference that in Example 1, the composite of Preparing Example 4 was used instead of the core-shell particle of Preparing Example 1.

### Comparative Example 3

A separator for a rechargeable lithium battery was manufactured in the same method as in Example 1, with a difference that in Example 1, alumina (particle diameter D50: 100 nm) was used instead of the core-shell particle of Preparing Example 1.

### Comparative Example 4

A separator for a rechargeable lithium battery was manufactured in the same method as in Example 1, with a difference that in Example 1, a mixture of alumina (particle diameter D50: 100 nm) and poly(vinylidene fluoride) (particle diameter D50: 1 μm) was used instead of the core-shell particle of Preparing Example 1.

### Confirmation of Core-Shell Particle (1)

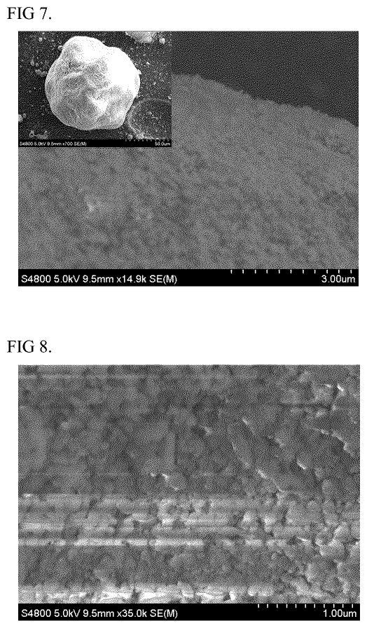

The core-shell particles prepared in Preparing Example 1 were confirmed by SEM. Referring to FIGS. 7 and 8, because alumina was uniformly coated on the surface of the polyvinylidene fluoride particles, core-shell particles composed of an alumina shell on a polyvinylidene fluoride particle core were prepared.

### Confirmation of Core-Shell Particle (2)

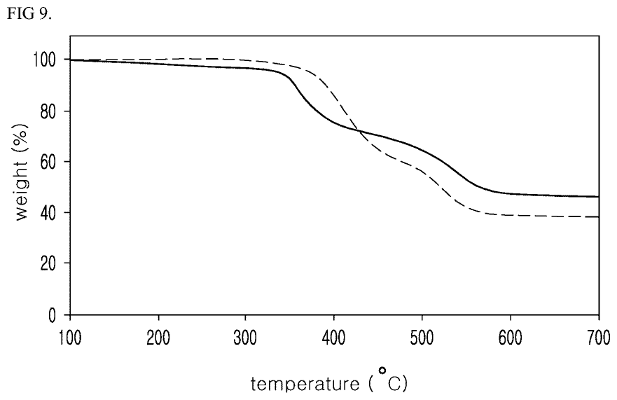

The core-shell particles prepared in Preparing Example 1 and the composite of polyvinylidene fluoride and alumina prepared in Preparing Example 3 were subjected to thermogravimetric analysis. The results thereof are shown in FIG. 9.

Referring to FIG. 9, a thermal decomposition temperature of the particle (solid line) prepared in Preparing Example 1 starts at a lower temperature than the particle (dotted line) prepared in Preparing Example 3. Although the particle (solid line) prepared in Preparing Example 1 had a remaining amount of about 46 wt % of an initial weight when heated to 700° C., the particle (dotted line) prepared in Preparing Example 3 had a remaining amount of about 39 wt % of the initial weight when heated to 700° C. Therefore, the remaining amount has increased by about 7% between Preparing Example 3 and Preparing Example 1. Therefore, the particle prepared in Preparing Example 1 has a substantially different form from the particle prepared in Preparing Example 3.

### Confirmation of Core-Shell Particle (3)

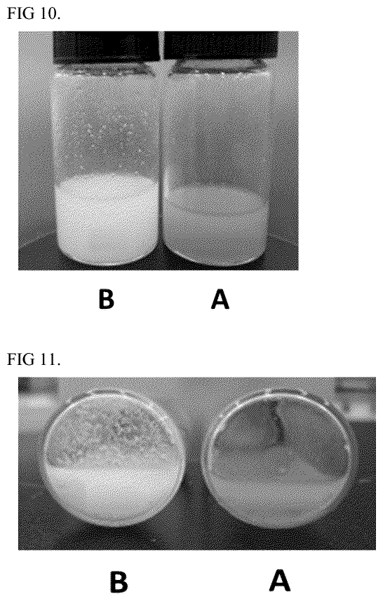

The degree of dispersion was confirmed by dissolving the core-shell particles prepared in Preparing Example 1 and the composite of polyvinylidene fluoride and alumina prepared in Preparing Example 3 in acetone. The results thereof are shown in FIGS. 10 and 11.

In FIGS. 10 and 11, A is the result of the core-shell particle of Preparing Example 1, and B is the result of the composite of Preparing Example 3. In FIGS. 10 and 11, in A, chemical bonding between the core and the shell occurred and the color of the particles changed to yellow, and no particles are present on the sides and bottom of the glass vial, indicating high dispersibility. On the other hand, in FIGS. 10 and 11, B shows a different color from A indicating no significant chemical bonding occurred between the core and the shell, and particles are present on the sides and bottom of the glass vial, indicating low dispersibility.

### Evaluation of Separator

### (1) Puncture Strength (Units: Kgf)

Each of the separators manufactured in Examples and Comparative Examples was cut at 10 different points with a width (MD) of 50 mm and a length (TD) of 50 mm to produce 10 samples, the samples were placed on a 10 cm hole using GATO Tech G5 equipment, and then the puncture force was measured while pressing the samples with a 1 mm probe. The puncture strength of each sample was evaluated three times, and an average value of the puncture strength was calculated therefrom.

### (2) Uniformity of Puncture Strength (Units: Kgf)

The puncture strength was evaluated in the same manner as above, but the uniformity of the puncture strength was evaluated through a difference between a maximum value of the puncture strength and a minimum value of the puncture strength.

(3) Air Permeability (Units: s/100 cc)

For the separators manufactured in Examples and Comparative Examples, air permeability was measured by measuring the time (units: seconds) it took for 100 cc of air to pass through the separator using a measuring device (EG01-55-1MR, Asahi Seiko). The air permeability was measured twice and the average value was obtained.

### Air Permeability Measurement Device Setting Conditions:

Measurement pressure: 0.5 kg/cm², cylinder pressure: 2.5 kg/cm², set time: 10 seconds

TABLE 1

| | Example | | | | Comparative Example | | | |
|---|---|---|---|---|---|---|---|---|
| | 1 | 2 | 3 | 4 | 1 | 2 | 3 | 4 |
| Binder | Binder 2 | Binder 2 | Binder 1 | Binder 1 | Binder 2 | Binder 2 | Binder 2 | Binder 2 |
| Particle | Preparing | Preparing | Preparing | Preparing | Preparing | Preparing | Alumina | Mixture of |
| | Example 1 | Example 2 | Example 1 | Example 2 | Example 3 | Example 4 | | alumina |
| | | | | | | | | and PVDF |
| Puncture | 709 | 714 | 697 | 704 | 611 | 618 | 554 | 573 |
| strength | | | | | | | | |
| Uniformity | (712 − | (716 − | (701 − | (706 − | (621 − | (626 − | (577 − | (598 − |
| of puncture | 706) | 712) | 693) | 702) | 601) | 610) | 531) | 548) |
| strength | 6 | 4 | 8 | 4 | 20 | 16 | 46 | 50 |
| Air | 182 | 188 | 179 | 181 | 151 | 153 | 141 | 155 |
| permeability | | | | | | | | |

As shown in Table 1 above, the core-shell structure-applied coatings of Examples 1 to 4 showed a significant puncture strength compared to Comparative Examples 1 to 4, and the uniformity thereof was desired or improved. The puncture strength was high in Examples 2 and 4, which had a high alumina content, and in particular, the puncture strength of Example 2 was higher than the puncture strength of Example 4. This difference is due to the fact that binder 2 has a higher non-volatile content than binder 1, resulting in increased bonding between the binder and the core-shell.

In terms of air permeability, Examples 1 to 4 showed higher Gurley values than Comparative Examples 1 to 4. This difference is due to the fact that the separator to which the core-shell structure was applied had improved dispersion, thereby increasing tortuosity. The air permeability of Comparative Examples 1 to 4 has low uniformity due to a difference between the minimum and maximum values, which is due to the low dispersion of PVDF and alumina contained in the coating layer.

Therefore, when a core-shell is prepared using mechanofusion and applied to a coating layer, a separator that has increased puncture strength, increased dispersibility, and a substantially uniform air permeability value can be prepared.

A separator for a rechargeable lithium battery according to an example embodiment can exhibit desired or improved dispersibility of inorganic fine particles, desired or improved puncture strength, and desired or improved puncture strength uniformity.

Although example embodiments of the present disclosure have been described above, the present disclosure is not limited thereto and may be modified in any form within the scope of the claims, the detailed description of the disclosure, and the accompanying drawings, and the modifications also fall within the scope of the present disclosure.

What is claimed is:

1. A separator for a rechargeable lithium battery, the separator comprising:
a porous substrate; and
a coating layer located on at least one surface of the porous substrate;
wherein the coating layer includes a binder and a core-shell particle including a fluorine-based resin particle core and an inorganic fine particle shell.

2. The separator of claim 1, wherein the inorganic fine particle is chemically bonded to the fluorine-based resin particle core.

3. The separator of claim 1, wherein the inorganic fine particle comprises at least one of alumina, SiO₂, TiO₂, SnO₂, CeO₂, MgO, NiO, CaO, GaO, ZnO, ZrO₂, Y₂O₃, SrTiO₃, BaTiO₃, Mg(OH)₂, and boehmite.

4. The separator of claim 1, wherein the fluorine-based resin particle comprises a homopolymer or a copolymer of one or more of vinylidene fluoride, chlorotrifluoroethylene, trifluoroethylene, hexafluoropropylene, and ethylene tetrafluoride.

5. The separator of claim 1, wherein the fluorine-based resin particle comprises one or more of poly(vinylidene fluoride) and poly(vinylidene fluoride-co-hexafluoropropylene).

6. The separator of claim 1, wherein the inorganic fine particle comprises alumina.

7. The separator of claim 1, wherein the fluorine-based resin particle has a particle diameter D50 ranging from about 200 nm to about 1 μm.

8. The separator of claim 1, wherein the inorganic fine particle has a particle diameter D50 ranging from about 10 nm to about 100 nm.

9. The separator of claim 1, wherein the fluorine-based resin particle is substantially spherical, and the inorganic fine particle is substantially plate-shaped.

10. The separator of claim 1, wherein the core-shell particle comprises an alumina shell on a poly(vinylidene fluoride) or poly(vinylidene fluoride-co-hexafluoropropylene) core.

11. The separator of claim 1, wherein, among 100 wt % of the core-shell particle, the core and the shell are included in a core:shell ratio ranging from about 90 wt %: 10 wt % to about 10 wt %: 90 wt %.

12. The separator of claim 1, wherein the binder and the core-shell particle are included in a weight ratio ranging from about 1:10 to about 1:50.

13. The separator of claim 1, wherein the binder comprises one or more of a sulfonate group-containing structural unit, a structural unit derived from (meth)acrylate or (meth)acrylic acid, a cyano group-containing structural unit, and a structural unit derived from (meth)acrylamide.

14. The separator of claim 1, wherein the binder comprises a sulfonate group-containing structural unit.

15. The separator of claim 14, wherein the sulfonate group-containing structural unit is included in the (meth)acryl-based binder in an amount in a range of about 0.1 mol % to about 20 mol %.

16. The separator of claim 14, wherein the sulfonate group-containing structural unit is represented by at least one or more of Chemical Formulas 1, 2, and 3 below: 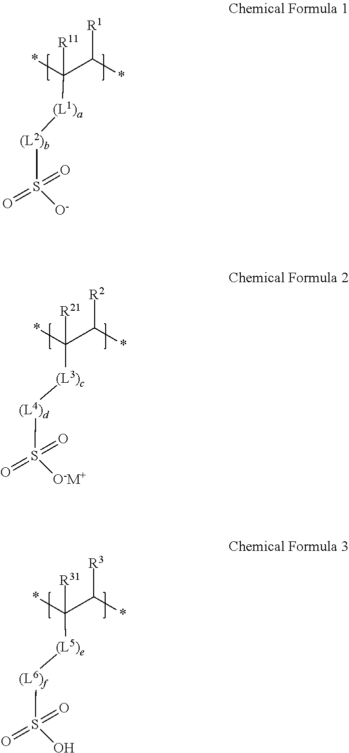
in Chemical Formulas 1 to 3:
R¹, R¹¹, R², R²¹, R³, and R³¹ each independently comprises hydrogen or a C1 to C5 alkyl group,
L¹, L³, and L⁵ each independently comprises —C(═O)—, —C(═O)O—, —OC(═O)—, —O—, or —C(═O)NH—,
L², L⁴, and L⁶ each independently comprises a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 arylene group,
a, b, c, d, e, and f are each integers independently ranging from 0 to 2, and
in Chemical Formula 2,
M comprises an alkali metal.

17. The separator of claim 14, wherein the binder further comprises one or more of a structural unit derived from (meth)acrylate or (meth)acrylic acid, a cyano group-containing structural unit, and a structural unit derived from (meth)acrylamide.

18. The separator of claim 17, wherein the (meth)acryl-based binder comprises the sulfonate group-containing structural unit, the structural unit derived from (meth)acrylate or (meth)acrylic acid, and the cyano group-containing structural unit.

19. The separator of claim 17, wherein the (meth)acryl-based binder comprises the sulfonate group-containing structural unit, the structural unit derived from (meth)acrylate or (meth)acrylic acid, and the structural unit derived from (meth)acrylamide.

20. A rechargeable lithium battery comprising:
the separator for a rechargeable lithium battery of claim 1;
a positive electrode; and
a negative electrode.
